(19) United States
(12) Patent Application Publication
(10) Pub. No.: US 2026/0048396 A1
(43) Pub. Date: Feb. 19, 2026

(54) Method for an Energy-Saving Garbage Recycling and Sorting Apparatus

(71) Applicant: Zhenkun Zack Wang, Cambridge, MA (US)

(72) Inventor: Zhenkun Zack Wang, Cambridge, MA (US)

(21) Appl. No.: 19/304,522

(22) Filed: Aug. 19, 2025

(30) Foreign Application Priority Data
Aug. 19, 2024 (CN) 2024111390620

(51) Int. Cl. B02C 23/14; B65F 1/14; B65F 7/00

(52) U.S. Cl. CPC B02C 23/14; B65F 1/14; B65F 7/00; B65F 2210/12; B65F 2210/176

(57) ABSTRACT

The present invention utilizes human technology to sort and recycle garbage for reuse, processing garbage with less energy to obtain raw materials whose value far exceeds the energy expended. Before sorting, the garbage is first crushed by a pulverize into small fragments of roughly equivalent size to facilitate the next step of classification. The present invention performs garbage classification through six sorting methods: washing, electromagnetic sorting, vacuum melting sorting, wind sorting, brine buoyancy sorting, and centrifugal sorting. During the garbage sorting process, gravity is utilized for layered sorting, allowing the garbage to naturally fall with the flow to save energy.

The present utility model relates to a method for an energy-saving garbage recycling and sorting apparatus, possessing garbage classification functionality, and encompassing the fields of physics, chemistry, machinery, biology, and others.

### BACKGROUND TECHNOLOGY

With the global urbanization process, excessive industrial production, and the extensive use of plastic products, the amount of garbage generated by humans is increasing, and non-degradable household waste is growing. Whether in cities or rural areas, the environmental pollution caused by garbage has become very severe. A portion of non-degradable garbage flows into rivers and oceans with surface water, while another portion is forgotten on the ground and buried in the soil. This garbage not only pollutes rivers and oceans but also contaminates land and soil. Furthermore, this non-degradable garbage is often ingested by various animals as food, cannot be excreted, and causes mass mortality.

Garbage disposal has become a major issue in urban development. The original disposal methods are landfilling and incineration. Both methods produce non-degradable garbage, causing harm to the ecological environment. The first method, landfilling, only temporarily handles garbage; the non-degradable substances in the garbage will permanently remain in the soil and do not actually solve the garbage problem. This method causes serious damage to the soil environment. The second method is incineration. Incineration is extremely wasteful of energy, and garbage incineration is incomplete in most places. The toxic and harmful gases produced during the incineration process pollute the environment. Especially for rural garbage, complete collection and centralized incineration are even more impractical. We must take decisive measures at this stage to prevent the situation from worsening further. In the process of using resources, we must have a recycling consciousness; we must reuse various resources within the garbage.

Among the existing methods for handling garbage, there is no good solution. Much of the garbage we produce can be utilized, such as converting organic matter into fertilizer. The organic fertilizer on Earth is inherently limited; more importantly, we need to establish this way of survival that involves the cyclic use of Earth's resources. By the time many creatures on Earth are extinct, it will be too late to realize we need to do something. Therefore, we must devote effort to researching how to separate recyclable materials from garbage; degradable materials can be made into organic fertilizer, and non-degradable metals can be recycled.

Therefore, researching a method for an energy-saving garbage sorting apparatus that can also recycle garbage is already urgent and concerns the future of human development and survival.

### Utility Model Content

To solve the problems of resource waste, environmental destruction, and harm to organisms in existing garbage disposal technologies, our current approach is to utilize human technology to sort and recycle garbage for reuse. Through this equipment, if waste can be converted into valuable resources, generating profit, and processing garbage with less energy to obtain raw materials whose value far exceeds the energy expended, then this apparatus will be easily promoted. It utilizes minimal energy to sort and reuse recyclable material resources from garbage. The present invention performs garbage classification through six sorting methods: washing, electromagnetic sorting, vacuum melting sorting, wind sorting, brine buoyancy sorting, and centrifugal sorting.

The technical solution adopted by the present invention is: employing a garbage recycling and sorting apparatus. The areas equipped with this apparatus are divided into two forms: centralized areas and decentralized areas. Decentralized areas are regions such as a building or a residential complex; the garbage recycling apparatus in such areas is equipped in the basement, and residents directly throw garbage into the garbage recycling apparatus. Centralized areas are densely populated areas of large cities; the garbage disposal apparatus in such areas is equipped in locations relatively close to residential areas. Garbage is uniformly transported to the garbage disposal site by garbage trucks.

The first step of the present invention is washing. The garbage truck transports the garbage to a washing tank, stirring and washing it while dumping. Garbage such as grease that is easily soluble in water is sorted out through washing. After washing is completed, the wastewater is drained through pipes into a dedicated sewage treatment tank and treated using existing sewage treatment technologies and processes. This stage mainly handles grease, kitchen waste, and other garbage easily soluble in water.

The second step of the present invention is electromagnetic sorting. Operated by computer, the electromagnet is energized to attract large iron objects, which are placed into a dedicated iron material collection box. This stage mainly handles large iron items.

The third step of the present invention is vacuum melting sorting. The principle utilized in this stage is that different plastics have different melting points. Using a heating plate for heating and melting, plastics are melted into liquid plastic and fall into a collection box through a filter screen. Furthermore, this process is conducted in a sealed vacuum environment, so without oxygen, combustion does not occur, and no harmful gases are produced. After electromagnetic sorting, the garbage is poured into a pulverizer, where it is crushed into small fragments by the pulverizer. After pulverization is completed, it falls into a vacuum chamber, which is a sealed space. Within this space, plastic garbage is melted by heating and pressurization and falls through a filter screen into a liquid plastic collection box. This stage mainly handles plastic garbage.

The fourth step of the present invention is wind sorting. The principle utilized in this stage is: under the same wind force, lighter objects are blown farther, while heavier objects are blown less far. After the garbage passes through the third step of vacuum melting sorting, the melting chamber door opens, allowing the garbage to fall into the wind sorting stage. Simultaneously, as the garbage falls, the blower starts working. Lightweight objects will be blown into distant collection boxes, for example: wood chips, paper scraps, etc. Heavier objects, due to gravity, will directly fall into the processing box below, preparing to enter the next stage. This stage mainly sorts wood chips, paper scraps, etc.

The fifth step of the present invention is brine buoyancy sorting. The principle utilized in this stage is: within a sealed space, the higher the pressure and temperature, the higher the saturation of the brine; the higher the brine saturation, the greater the buoyancy; the greater the buoyancy, the higher the density of the substances that float. Temperature and pressure are controlled via an air compressor and heating plate. Under different temperatures and pressures, brine saturation differs, and buoyancy magnitude varies. During the continuous process of heating and pressurization, different substances in the garbage float up sequentially from light to heavy. After substances of the same kind float up, they are collected into different collection boxes by a push plate. This stage mainly sorts metal items.

The sixth step is centrifugal sorting. The centripetal force required for an object to maintain circular motion on the sorting disc is Fc (Fc=mω²r), and the centripetal force is provided by the frictional force (f=μmg) acting on the object. That is, when the object maintains uniform circular motion, F_c=f. Since the objects all move within the same orbit and are crushed into small fragments, the influence of mass on friction is not significant. Therefore, in this invention, r is invariant, m is invariant, and g is constant. Thus, it can be known that in this invention, the centripetal force required to maintain circular motion is related to the turntable rotation speed ω, and the frictional force acting on the object is related to the friction coefficient ρ. Since when an object undergoes circular motion, the faster the rotation speed, the greater the required centripetal force. When the frictional force is less than the centripetal force required to maintain circular motion, that is, when f<F_c, the object will be flung off the disc. Therefore, as the sorting disc gradually increases its rotational speed, the centripetal force required by the objects also increases. Different objects are thrown off the sorting disc at different times, thereby achieving classification.

### DESCRIPTION OF DRAWINGS

FIG. 1 is the external view.

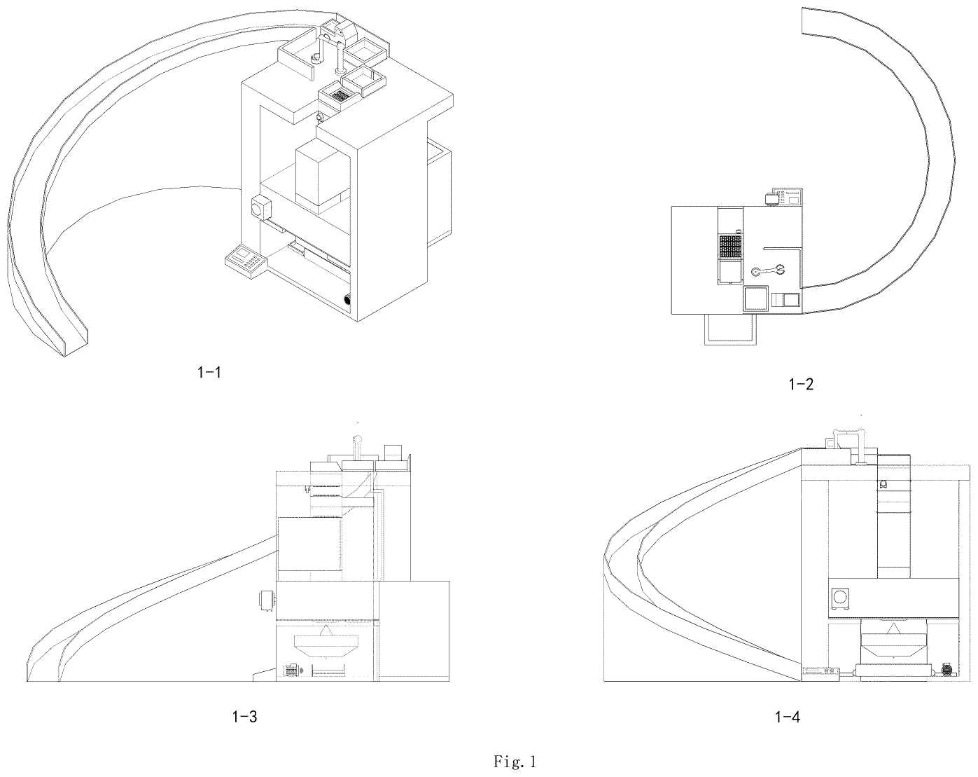

FIG. 2 is the electromagnetic sorting structure and workflow diagram.

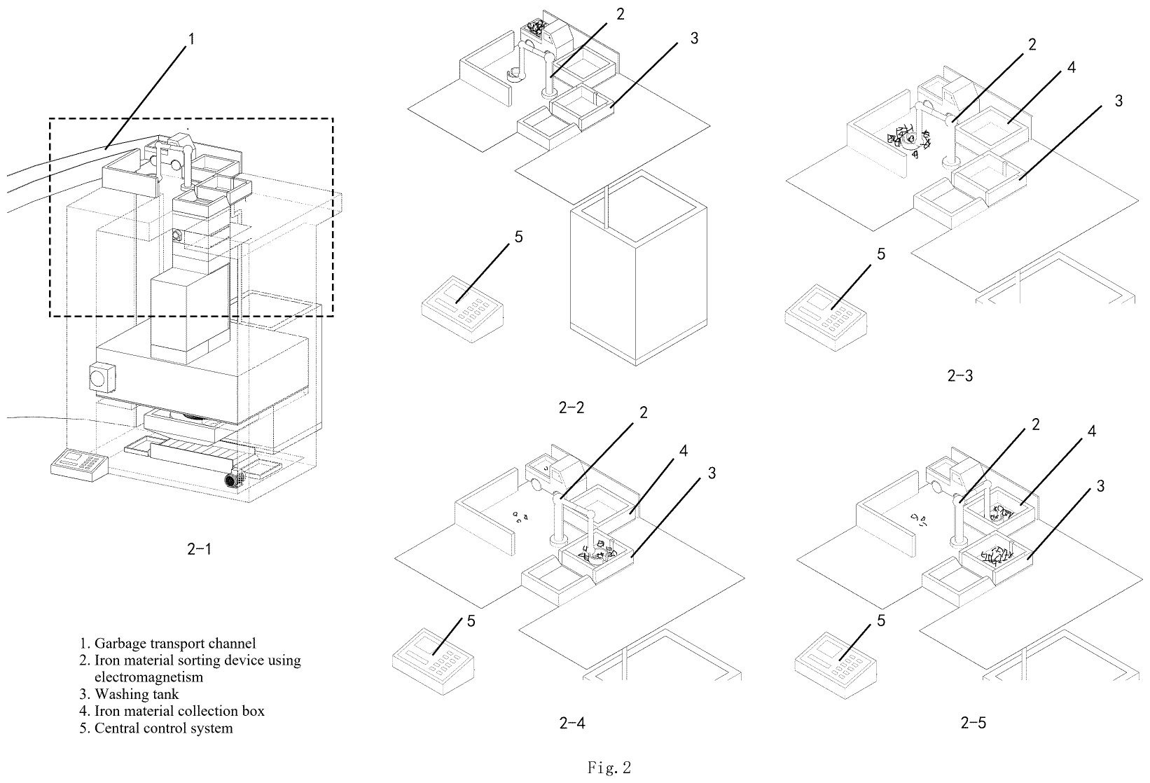

FIG. 3 is the washing work and sewage treatment diagram.

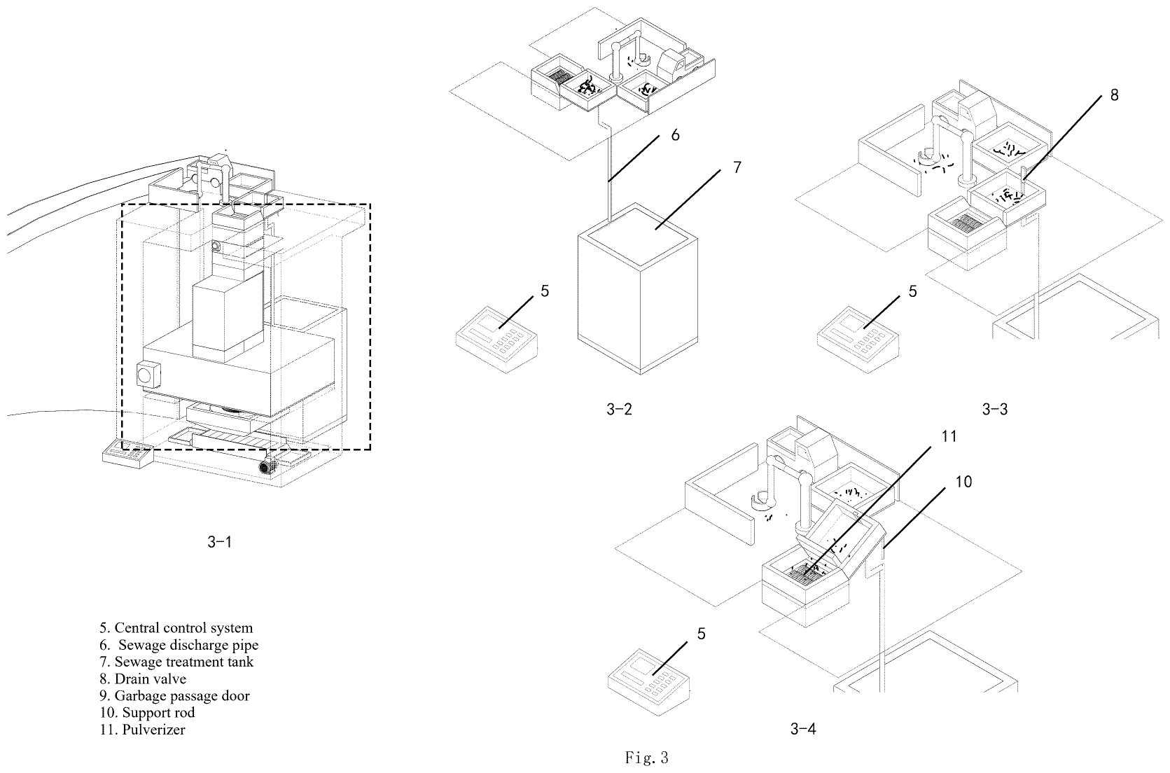

FIG. 4 is the structure and workflow diagram 1 of the plastic melting chamber under vacuum conditions.

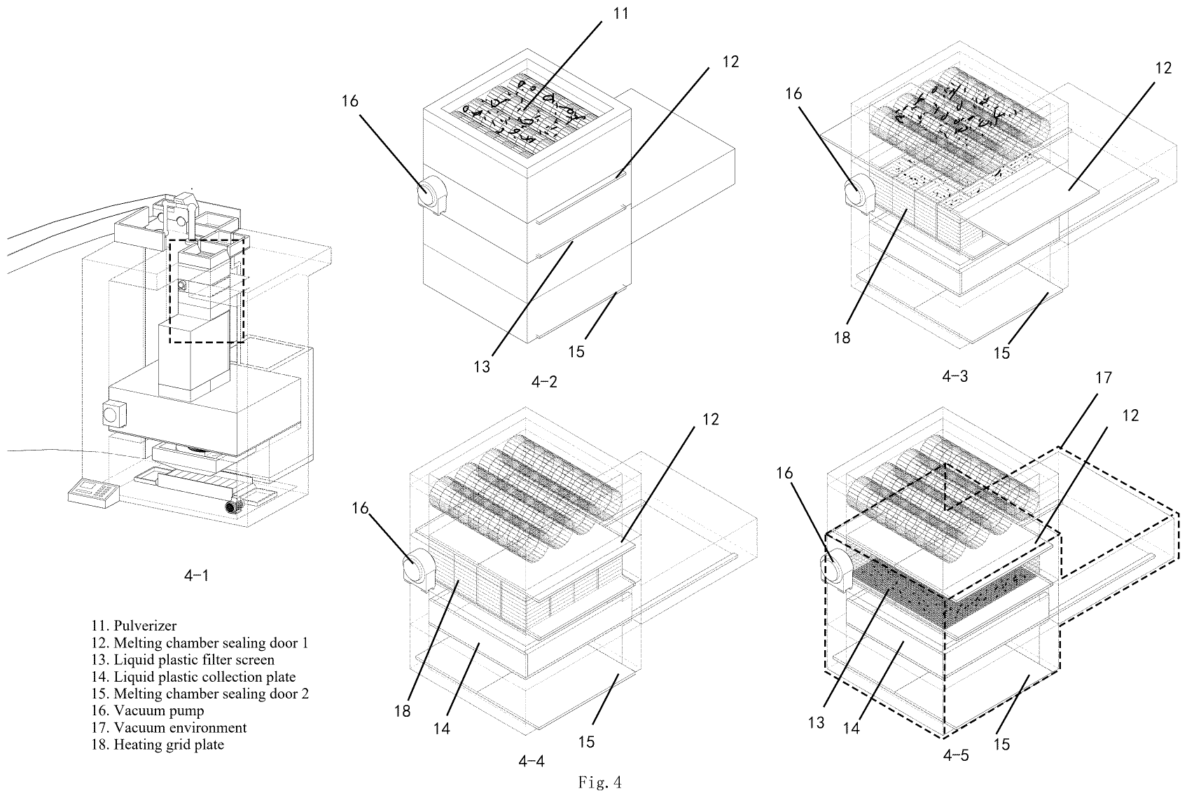

FIG. 5 is the structure and workflow diagram 2 of the plastic melting chamber under vacuum conditions.

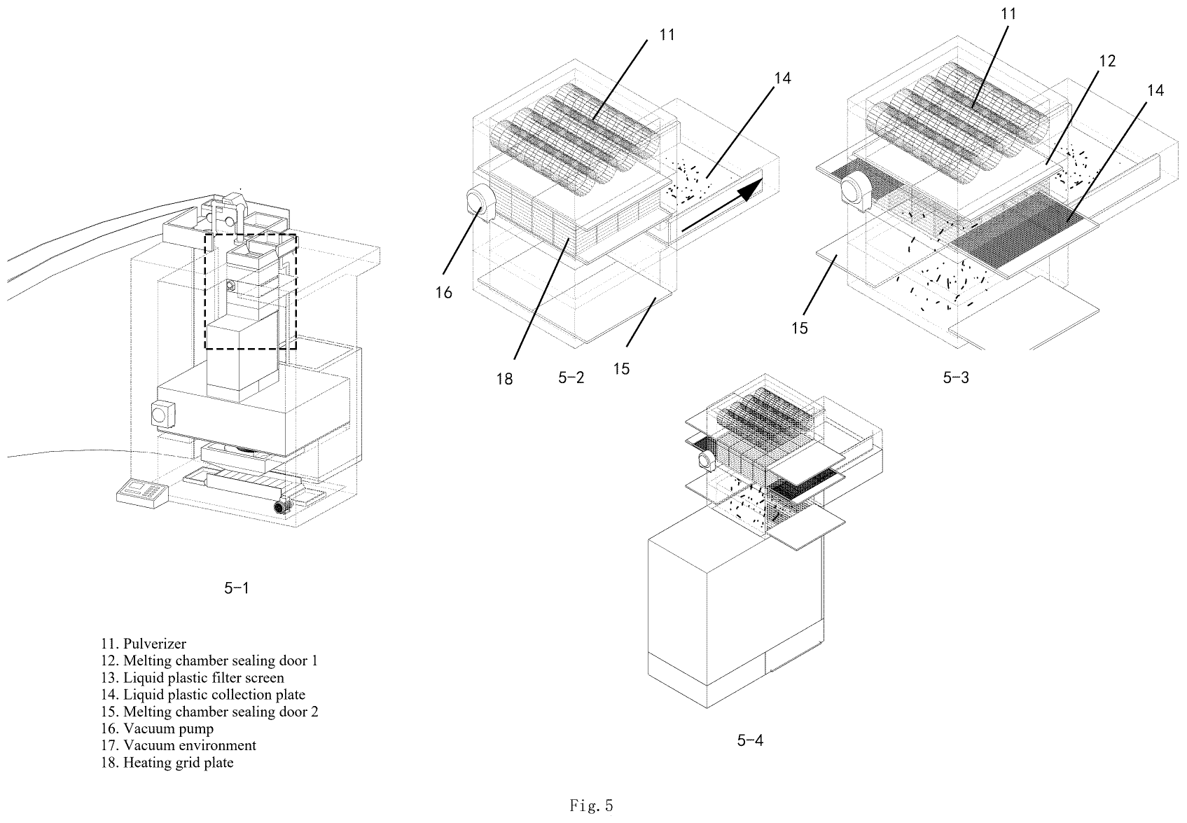

FIG. 6 is the structure and workflow diagram 3 of the plastic melting chamber under vacuum conditions.

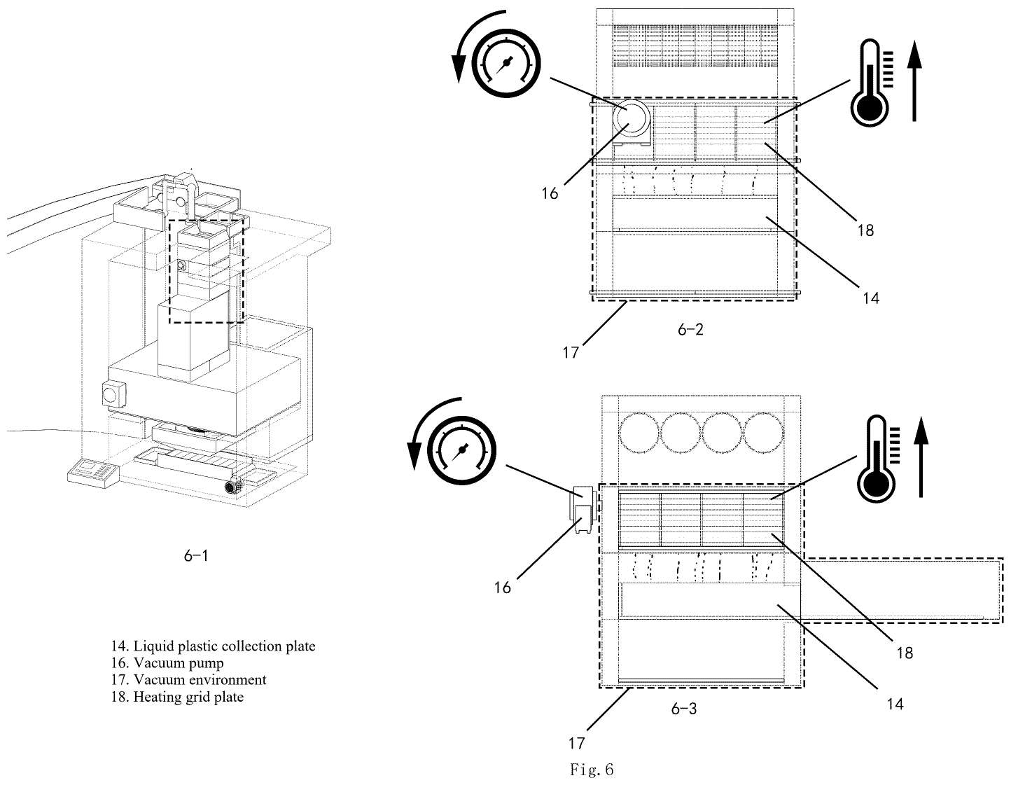

FIG. 7 is the wind sorting workflow diagram.

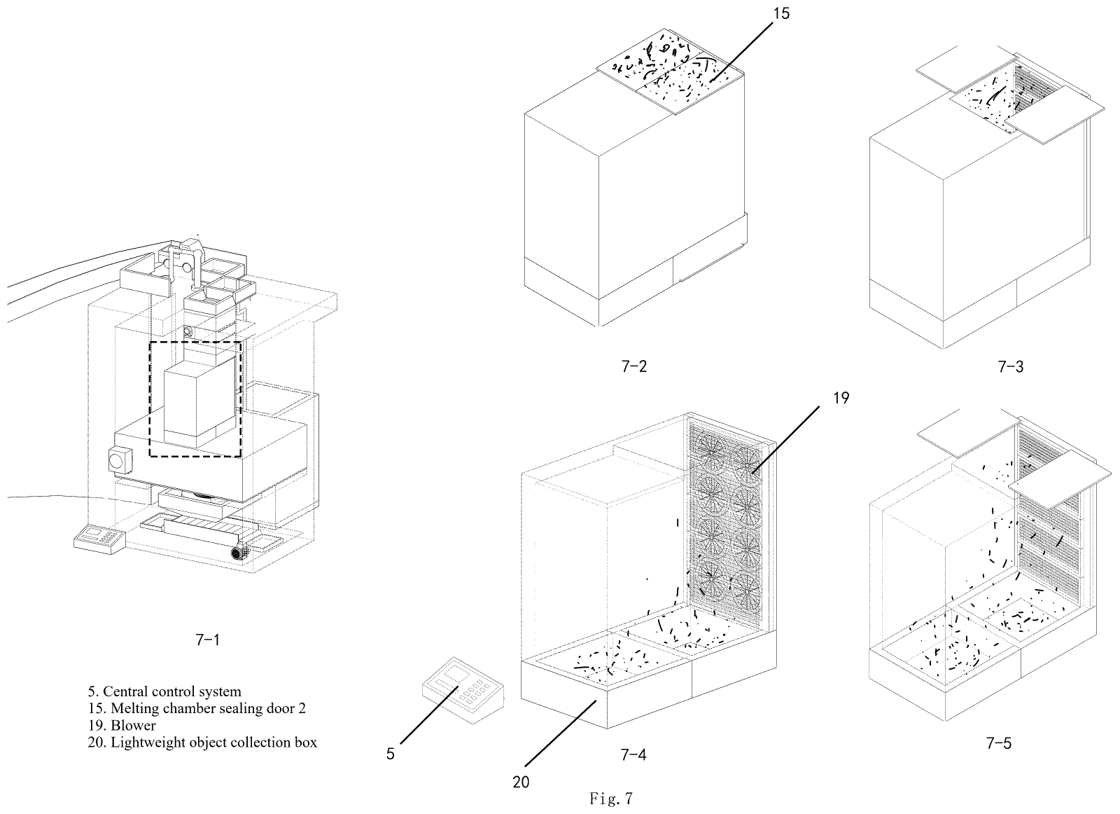

FIG. 8 is the structure and workflow diagram 1 of the sorting apparatus using different buoyancy under different brine saturation levels.

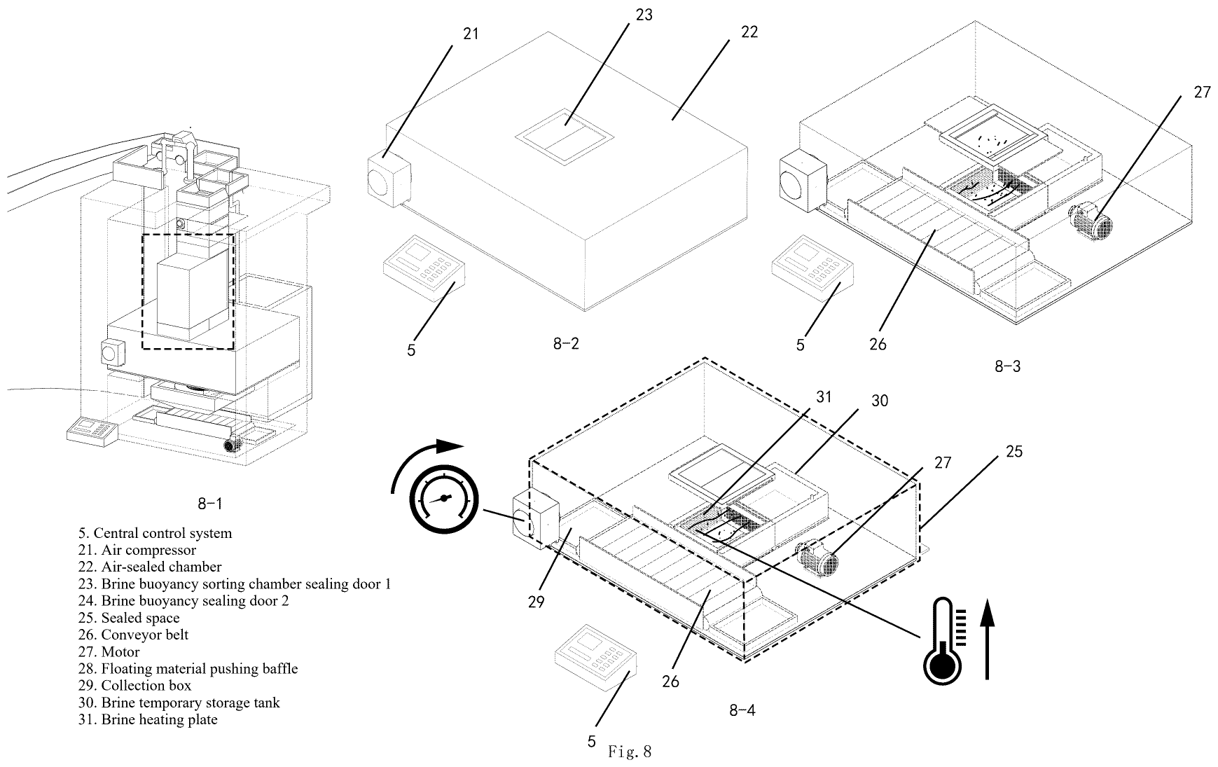

FIG. 9 is the structure and workflow diagram 2 of the sorting apparatus using different buoyancy under different brine saturation levels.

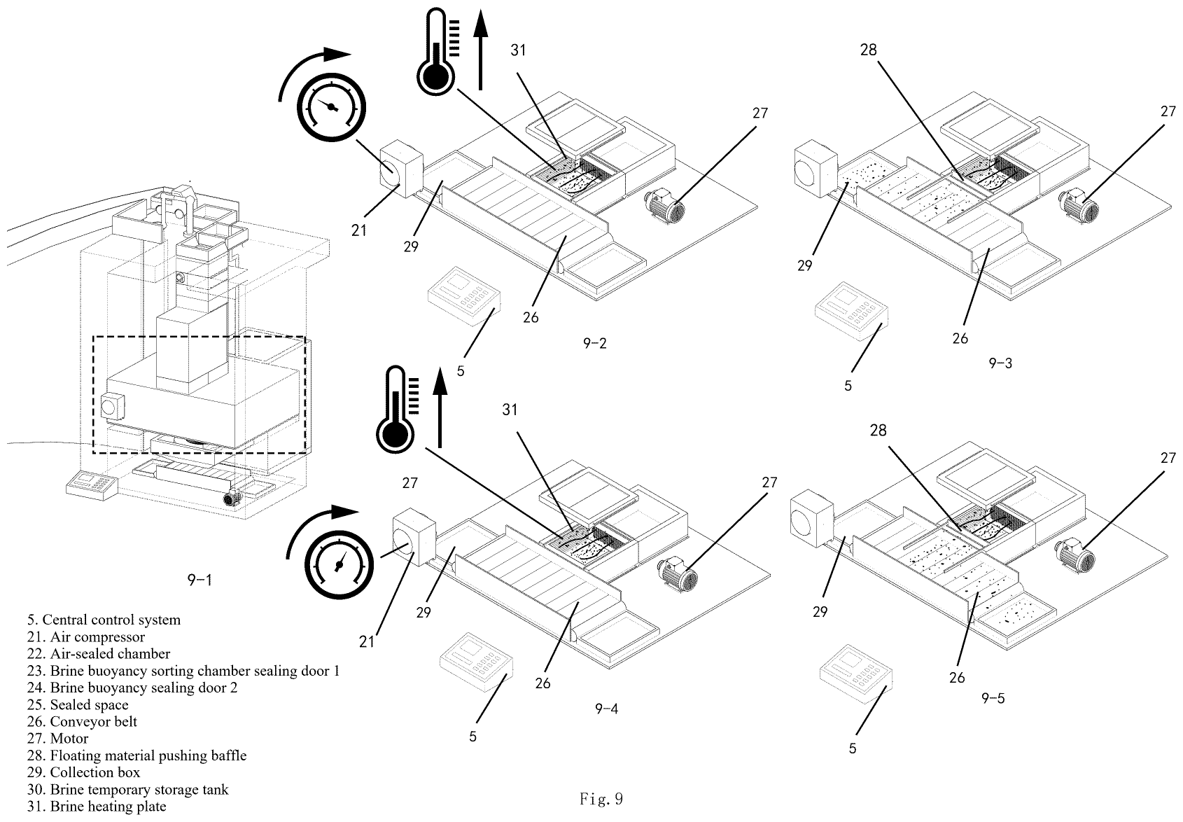

FIG. 10 is the brine buoyancy sorting structure and workflow diagram.

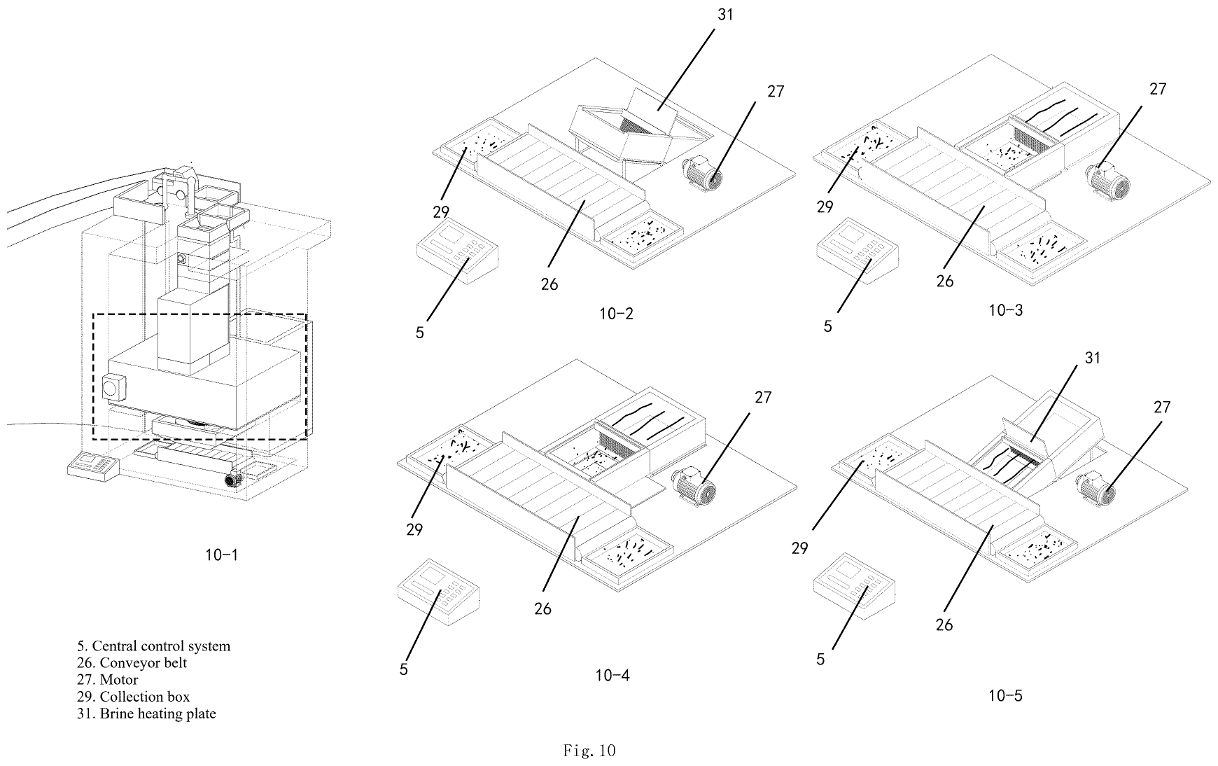

FIG. 11 is the centrifuge sorting structure and workflow diagram.

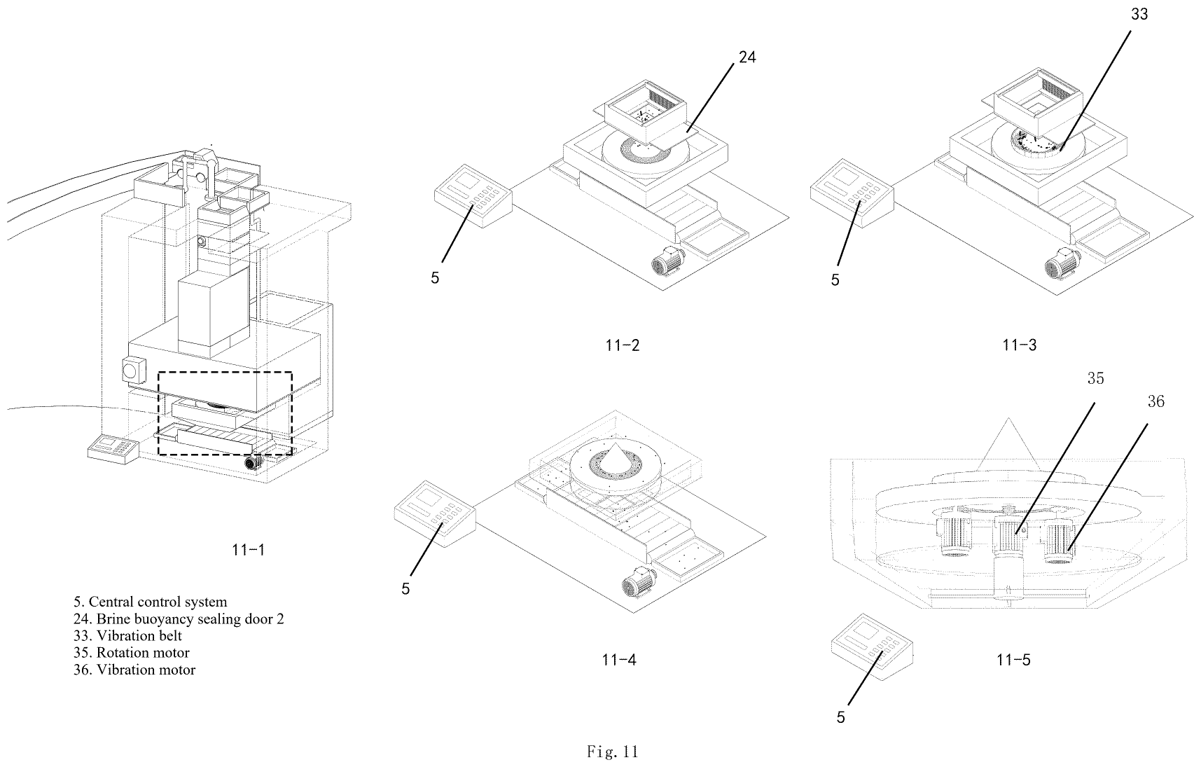

### IN THE FIGURES

Garbage transport channel
Iron material sorting device using electromagnetism
Washing tank
Iron material collection box
Central control system
Sewage discharge pipe
Sewage treatment tank
Drain valve
Garbage passage door
Support rod
Pulverizer
Melting chamber sealing door 1
Liquid plastic filter screen
Liquid plastic collection plate
Melting chamber sealing door 2
Vacuum pump
Vacuum environment
Heating grid plate
Blower
Lightweight object collection box
Air compressor
Air-sealed chamber
Brine buoyancy sorting chamber sealing door 1
Brine buoyancy sealing door 2
Sealed space
Conveyor belt
Motor
Floating material pushing baffle
Collection box
Brine temporary storage tank
Brine heating plate
Brine filter valve
Vibration belt
Lifting barrier
Rotation motor
Vibration motor

### Detailed Embodiment

Garbage trucks transport garbage to the washing tank 3 via the garbage transport channel 1, stirring and washing while dumping. After washing is completed, the central control system 5 controls the iron material sorting device using electromagnetism 2 to energize, attracting large iron materials via the electromagnet into the iron material collection box 4. After washing, the drain valve 8 is opened to allow sewage to drain through the sewage discharge pipe 6 into the sewage treatment tank 7 for treatment using existing sewage treatment technology.

After the first step is completed, the garbage passage door 9 is opened, then the support rod 10 is raised to tilt the garbage collection box and pour the garbage into the pulverizer 11. After pulverization is completed, the garbage becomes small fragments and enters the melting chamber. After the garbage enters the melting chamber, the melting chamber sealing door 1 (12) and the melting chamber sealing door 2 (15) are closed to ensure the entire process is conducted in a vacuum environment 17. After sealing is complete, the environment is evacuated into a vacuum by the vacuum pump 16. Then, the central control system 5 heats the heating grid plate 18, with the heating range being the temperature range for plastic melting. During the heating process, plastic garbage melts into a liquid state and falls through the liquid plastic filter screen 13 into the liquid plastic collection plate 14. After heating is complete and all plastic garbage is separated, the liquid plastic collection plate 14 is removed, then the melting chamber sealing door 2 (15) is opened, allowing the garbage to fall into the next stage.

Before the garbage falls in, the blower 19 is turned on. As the garbage falls, it is blown; lightweight garbage, under the action of the wind force, falls into the lightweight object collection box 20, while heavier materials fall onto the brine buoyancy sorting chamber sealing door 1 (23).

In the brine sorting stage, first open the brine buoyancy sorting chamber sealing door 1 (23) to allow the garbage to fall into the brine pool. Then close the brine buoyancy sorting chamber sealing door 1 (23) so that the entire process is within the sealed space 25. Then, through the central control system 5, control the air compressor 21 and the brine heating plate 31 to increase temperature and pressure. Under the action of brine buoyancy, garbage floats up one by one from light to heavy. The floated garbage is pushed by the floating material pushing baffle 28 onto the conveyor belt 26. The conveyor belt 26 then collects the garbage into collection boxes 29, with lighter materials collected into the left collection box 29 and heavier materials into the right collection box 29. After collection is complete, the brine filter valve 32 is opened, and then the brine tank is tilted using the support rod to allow the brine to enter the brine temporary storage tank 30. After brine processing is completed, open the brine buoyancy sorting chamber sealing door 2 (24) to allow the garbage to fall into the next stage. After the garbage has completely fallen, open the brine filter valve 32 again to allow the brine to return to the brine pool for next use.

The final stage is the centrifugal sorting stage. Before garbage falls through the brine buoyancy sorting chamber sealing door 2 (24) into the centrifugal sorting stage, the lifting barrier 34 must first be raised under the control of the central control system 5 to prevent the garbage from scattering. After raising it, the vibration motor 36 vibrates the garbage on the vibration belt 33 to achieve uniform distribution. Then retract the lifting barrier 34. Under the action of the rotation motor 35, the disc rotates continuously, maintaining different speeds for several minutes each, causing the garbage to be flung off progressively from light to heavy into collection boxes. This step mainly sorts garbage not completely separated by the above methods, performing the final classification.

The foregoing description of the disclosed embodiments enables any person skilled in the art to make or use the present invention. Various modifications to these embodiments will be readily apparent to those skilled in the art, and the generic principles defined herein may be applied to other embodiments without departing from the spirit or scope of the utility model. Thus, the present invention is not intended to be limited to the embodiments shown herein but is to be accorded the widest scope consistent with the principles and novel features disclosed herein.

1. A method for an energy-saving garbage recycling and sorting apparatus, its structural characteristic comprising:
utilizing gravity for layered sorting during the garbage sorting process, such that as the sorting progresses step by step, the garbage naturally falls from top to bottom due to the action of gravity;
crushing garbage by a pulverizer into small fragments of roughly equivalent size to facilitate the next step of classification; and
reusing brine in a brine pool, wherein water is filtered out when the salt saturation is at its maximum, then pressure and temperature are lowered, and the brine is returned to the brine pool, thereby reducing salt loss.

2. The method of claim 1, further comprising washing the garbage to remove dust, grease, and water from the garbage, and then cleaning water-soluble kitchen waste impurity garbage using existing sewage treatment technology.

3. The method of claim 1, further comprising melting plastic in a high-temperature, oxygen-free environment, wherein because there is no oxygen, plastic combustion does not occur and no harmful gases are produced, and wherein plastics with different melting points are melted by gradually increasing the temperature, thereby separating different plastics.

4. The method of claim 1, further comprising utilizing the principle that under the same wind force, lighter objects are blown farther and heavier objects are blown less far to perform classification.

5. The method of claim 1, further comprising:
providing a sealed space;
increasing pressure and temperature within the sealed space to increase the saturation of the brine;
wherein higher pressure and temperature result in higher brine saturation, and higher brine saturation results in greater buoyancy, and greater buoyancy results in a higher density of substances that float;
wherein buoyancy is progressively increased by continuously increasing pressure and temperature; and
wherein, as buoyancy gradually increases, objects of different masses gradually float upward for classification under the action of buoyancy.

6. The method of claim 1, wherein in a final sorting step, the centripetal force required for an object to maintain circular motion on a sorting disc is F_c=mω²r, and the centripetal force is provided by a frictional force f=μmg acting on the object, such that when the object maintains uniform circular motion, Fc=f.

7. The method of claim 6, wherein since the objects all move within the same orbit and are crushed into small fragments, the influence of mass on friction is not significant, and wherein r is invariant, m is invariant, and g is constant, such that the centripetal force required to maintain circular motion is related to the turntable rotation speed ω, and the frictional force acting on the object is related to the friction coefficient μ.

8. The method of claim 7, wherein when an object undergoes circular motion, the faster the rotation speed, the greater the required centripetal force; when the frictional force is less than the centripetal force required to maintain circular motion, that is, when f<Fc, the object is flung off; and wherein, as the sorting disc gradually accelerates its rotational speed, the centripetal force required by the objects increases, and different objects are flung off the sorting disc at different times, thereby achieving classification.

9. The method of claim 8, wherein garbage fragments are spread flat on an annular sorting area of the sorting disc, and by gradually accelerating the rotational speed of the sorting disc, garbage fragments of different materials are flung off the sorting disc at different times, thereby achieving the purpose of sorting garbage.

10. An energy-saving garbage recycling and sorting apparatus, comprising:
a pulverizer configured to crush garbage into small fragments of roughly equivalent size;
a brine pool configured to receive and reuse brine, wherein water is filtered out when the salt saturation is at its maximum, pressure and temperature are lowered, and the brine is returned to the brine pool to reduce salt loss;
a washing unit configured to remove dust, grease, and water from garbage, and to clean water-soluble kitchen waste impurity garbage using existing sewage treatment technology;
a plastic melting unit configured to melt plastic in a high-temperature, oxygen-free environment to prevent combustion and harmful gas production, wherein plastics with different melting points are melted by gradually increasing temperature to achieve separation;
a wind-sorting unit configured to classify objects by utilizing the principle that under the same wind force, lighter objects are blown farther and heavier objects are blown less far;
a sealed chamber containing brine, configured to increase pressure and temperature to progressively increase brine saturation and buoyancy, thereby causing objects of different masses to float upward at different times for classification; and
a sorting disc having an annular sorting area, configured to spread garbage fragments flat and to gradually accelerate its rotational speed such that objects are flung off at different times according to their frictional and centripetal force balance, thereby achieving classification.

11. The apparatus of claim 10, wherein the sorting disc is configured such that the centripetal force required for an object to maintain circular motion is F_c=mω²r, the frictional force is f=μmg, and classification occurs when f<Fc.

12. The apparatus of claim 11, wherein r is invariant, m is invariant, and g is constant, such that the centripetal force is related to turntable rotation speed ω, and the frictional force is related to friction coefficient μ.
